(19) United States
(12) Patent Application Publication
(10) Pub. No.: US 2012/0307003 A1
(43) Pub. Date: Dec. 6, 2012

(54) IMAGE SEARCHING AND CAPTURING SYSTEM AND CONTROL METHOD THEREOF

(76) Inventors: Po-Hsuan Huang, Taipei (TW); Yung-Hsiang Chen, Hsinchu City (TW); Ming-Fu Chen, Taipei (TW)

(21) Appl. No.: 13/179,795

(22) Filed: Jul. 11, 2011

(30) Foreign Application Priority Data
May 31, 2011 (TW) 100118974

(51) Int. Cl. H04N 5/225

(52) U.S. Cl. 348/37; 348/E05.024

(57) ABSTRACT

The present invention discloses an image searching and capturing system and a control method thereof. The system comprises a first capture device, a second capture device, a control module and a processing module. The first capture device captures a plurality of multi-spectral panoramic images with panorama. The control module controls the second capture device to search and target an azimuth of target object according to the plurality of multi-spectral panoramic images; the control module controls that the second capture device rotates a rotation module to capture a high-resolution image of a target object. The control module controls a rotation angle and a rotation direction of the rotation module according to attitude information, position information, and azimuth of the target object. The invention is applied to environmental monitoring and disaster monitoring, and has automatic search for targets, calibration targets and achieve high-resolution images and other effects.

### FIELD OF THE INVENTION

The present invention relates to a an image searching and capturing system and a control method thereof, in particular to an image searching and capturing system and a control method thereof provided for capturing multi-spectral panoramic images and searching a target object to obtain a high-resolution image of the target object.

### BACKGROUND OF THE INVENTION

In recent years, the earth environment and climate have tremendous changes caused by global climate anomalies, global warning, and frequently-occurred natural disasters such as typhoons, earthquakes, and floods. For remote areas or areas with only one external road, once the disaster occurs and the external road is cut off, aerial vehicles are needed to fly to the disaster areas to take photos or record the latest status of the disaster. For example, unmanned aerial vehicles (UAV) or unmanned aircraft systems are used for rescues or disaster surveys. For the requirement of the disaster survey, an image capture system can be installed in the UAV.

However, most conventional image capturing systems shoot or record an image with a small field of view or a large field of view. The image captured through a small field of view has a narrow image field of view, and fails to survey an object within a large range. On the other hand, the image captured through a large field of view provides a large image field of view, but fails to search or monitor a specific target object.

In addition, a conventional image capturing system can capture and store panoramic images or high-resolution images with a small field of view, but such image capturing system is unable to search a specific target through the panoramic images or capture a high-resolution image of a specific target.

Therefore, designing an image searching and capturing system and a control method thereof, applying such system and method to environmental monitoring and disaster monitoring, and capturing and targeting high-resolution images of a search target demands immediate attentions and feasible solutions.

### SUMMARY OF THE INVENTION

In view of the shortcomings of the prior art, it is a primary objective of the present invention to provide an image searching and capturing system and a control method thereof to overcome the problems of the conventional image searching and capturing system that fails to capture an image with a small field of view or a large field of view from an aerial vehicle directly or overcome the problems of having a smaller image field of view, failing to search or monitor a target object in a large range.

To achieve the foregoing objective, the present invention provides an image searching and capturing system, comprising a first capture device, a second capture device, a control module and a processing module. The first capture device comprises a panoramic capture module, and a time-sequence multi-spectral capture module. The panoramic capture module comprises a panoramic lens, a sensing unit and an imaging unit. The panoramic capture module forms a panoramic image at the imaging unit by passing a light source through the panoramic lens and the sensing unit, and the panoramic capture module integrates the time-sequence multi-spectral capture module, and the time-sequence multi-spectral capture module captures the multi-spectral panoramic images with panorama sequentially. The second capture device comprises a high resolution capture module and a rotation module, and the second capture device rotates the rotation module to capture a high-resolution image of a target object. The control module is coupled to the first capture device and the second capture device for controlling the second capture device to search and target an azimuth of the target object according to the multi-spectral panoramic images and an image characteristic parameter of the target object, and the control module controls the second capture device to rotate the rotation module to capture a high-resolution image of the target object. The processing module is electrically coupled to the control module for sensing a 3D acceleration to compute attitude information or inertia data, and receive a GPS signal and compute the inertia data to obtain position information and an azimuth of the target object.

Wherein, the control module controls a rotation angle and a rotation direction of the rotation module according to the attitude information, the position information and the azimuth of the target object.

Wherein, the storage module stores the high-resolution image of the target object, the attitude information, the position information and the azimuth of the target object, and a capturing time of the high-resolution image of the target object.

Wherein, the first capture device further comprises an input unit for inputting an image characteristic parameter of the target object.

Wherein, the time-sequence multi-spectral capture module further comprises a sensing unit coupled to the control module, and the control module controls a capture frequency of the sensing unit or a speed of switching a multi-spectral filter, and the time-sequence multi-spectral capture module captures a plurality of multi-spectral panoramic images sequentially.

Wherein, the control module remotely controls a first capture device and a second capture device, and the second capture module searches a target object according to the attitude information, the position information and the image characteristic parameter of the target object to capture a high-resolution image of the target object.

To achieve the objective of the present invention, the present invention further provides a control method, comprising the steps of:

providing a panoramic capture module to form an image at an imaging unit by passing a light source through a panoramic lens and a sensing unit; capturing a plurality of multi-spectral panoramic images sequentially by a time-sequence multi-spectral capture module; controlling a second capture device by a control module to search and target the azimuth of the target object according to the multi-spectral panoramic images and an image characteristic parameter of the target object; controlling the second capture device by the control module to rotate a rotation module to capture a high-resolution image of a target object; providing a processing module to sense a 3D acceleration to compute attitude information or inertia data; and receiving a GPS signal through the processing module and computing the inertia data to obtain position information and an azimuth of the target object.

Wherein, this method further comprises the step of controlling a rotation angle and a rotation direction of the rotation module by the control module according to the attitude information, the position information and the azimuth of the target object.

Wherein, this method further comprises the steps of using the storage module to store the high-resolution image of the target object, the attitude information, the position information and the azimuth of the target object, and a capturing time of the high-resolution image of the target object.

Wherein, this method further comprises the step of providing an input unit for inputting an image characteristic parameter of the target object.

Wherein, this method further comprises the steps of providing a control module to control a capture frequency of the sensing unit or a speed of switching a multi-spectral filter; and using the time-sequence multi-spectral capture module to capture a plurality of multi-spectral panoramic images synchronously.

Wherein, this method further comprises the steps of using the control module to remotely control a first capture device and a second capture device; providing a second capture module to search or target a target object according to the attitude information, the position information, and the image characteristic parameter of the target object; and using the second capture module to capture a high-resolution image of the target object.

In summation of the description above, image searching and capturing system and a control method thereof in accordance with the present invention can overcome the problems of the prior art that captures images by a camera with a small field of view or a large field of view only, such that the image with a smaller image field of view fails to search or monitoring an object in a large area. The image searching and capturing system and the control method of the present invention can obtain a plurality of multi-spectral panoramic images with panorama by the first capture device, and search and target an azimuth of the target object according to the multi-spectral panoramic images by the control module, and control the second capture device to rotate the rotation module to capture a high-resolution image of the target object. In addition, the control module is provided for controlling the rotation angle and rotation direction of the rotation module according to the attitude information, the position information and the azimuth of a target object. The invention can be applied effectively for environmental monitoring and disaster monitoring and achieving the effect of searching and targeting the target object and obtain a high-resolution image.

The technical characteristics and effects of the present invention will become apparent in the detailed description of the preferred embodiments with reference to the accompanying drawings as follows.

### BRIEF DESCRIPTION OF THE DRAWINGS

FIG. 1 is a block diagram of an image searching and capturing system of the present invention;

FIG. 2 is a schematic view of an image searching and capturing system of the present invention;

FIG. 3 is a schematic view of an image searching and capturing system in accordance with a first preferred embodiment of the present invention;

FIG. 4A is a schematic view of a first image of an image searching and capturing system in accordance with a first preferred embodiment of the present invention;

FIG. 4B is a schematic view of a second image of an image searching and capturing system in accordance with a first preferred embodiment of the present invention;

FIG. 4C is a schematic view of a third image of an image searching and capturing system in accordance with a first preferred embodiment of the present invention;

FIG. 5 is a schematic view of an image searching and capturing system in accordance with a second preferred embodiment of the present invention;

FIG. 6A is a schematic view of a first image of an image searching and capturing system in accordance with a second preferred embodiment of the present invention;

FIG. 6B is a schematic view of a second image of an image searching and capturing system in accordance with a second preferred embodiment of the present invention;

FIG. 6C is a schematic view of a third image of an image searching and capturing system in accordance with a second preferred embodiment of the present invention; and

FIG. 7 is a flow chart of an image searching, capturing control method of the present invention.

### DESCRIPTION OF THE PREFERRED EMBODIMENTS

The technical characteristics and contents of the present invention will become apparent with the following detailed description and related drawings. It is noteworthy to point out that same numerals are used for representing respective same elements in the drawings.

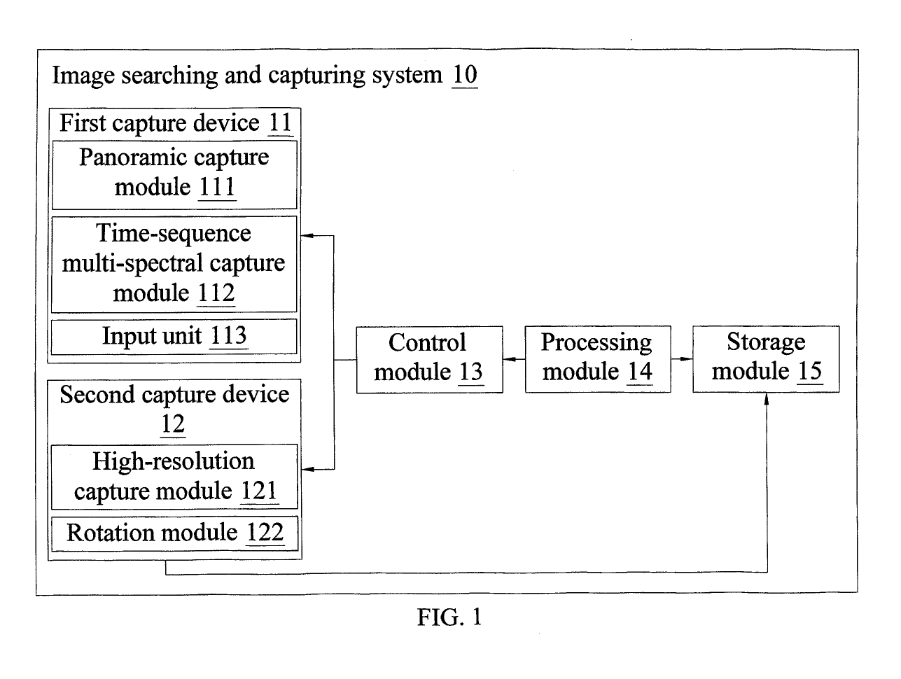

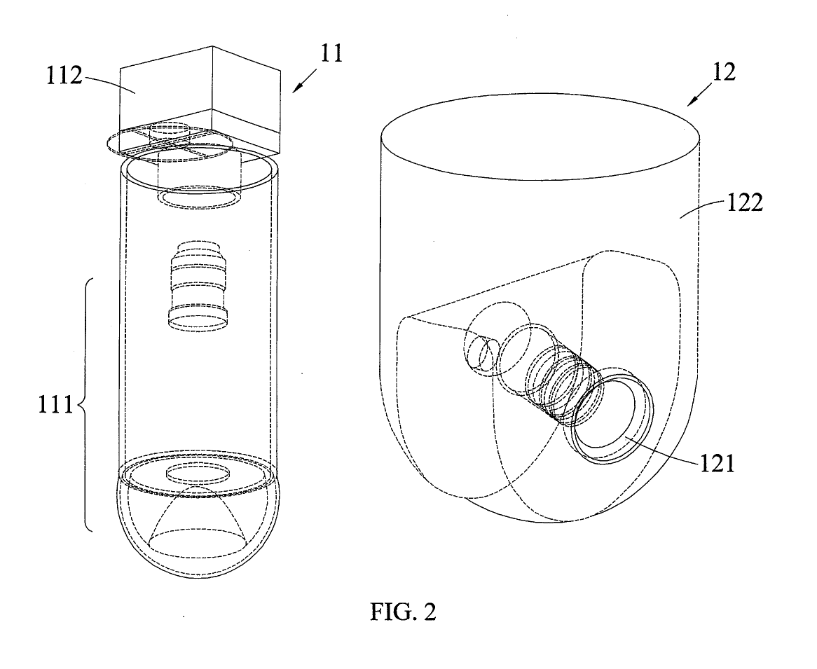

With reference to FIG. 1 for a block diagram of an image searching and capturing system of the present invention, the image searching and capturing system comprises a first capture device 11, a second capture device 12, a control module 13, a processing module 14 and a storage module 15. The first capture device 11 comprises a panoramic capture module 111, a time-sequence multi-spectral capture module 112 and an input unit 113. With reference to FIG. 2 for a schematic view of an image searching and capturing system of the present invention, the panoramic capture module 111 as shown in FIGS. 1 and 2 integrates the time-sequence multi-spectral capture module 112.

Wherein, the panoramic capture module 111 comprises a panoramic lens, a sensing unit and an imaging unit, and the panoramic capture module 111 can form a panoramic image at the imaging unit by passing a light source through the panoramic lens and the sensing unit. In addition, the time-sequence multi-spectral capture module 112 can capture a plurality of multi-spectral panoramic images with panorama sequentially, and the time-sequence multi-spectral capture module 112 comprises a sensing unit coupled to the control module 13 for controlling a capture frequency of the sensing unit or a speed of switching a multi-spectral filter, and the time-sequence multi-spectral capture module 112 captures the multi-spectral panoramic images synchronously. The input unit 113 is provided for inputting of an image characteristic parameter of the target object.

In particular, the sensing unit of the time-sequence multi-spectral capture module 112 controls the capture frequency of the sensing unit and the speed of switching the multi-spectral filter through the control unit 13, wherein a high rotation is provided for switching the multi-spectral filter such that the time-sequence multi-spectral capture module 112 can capture multi-spectral images, and the time of capturing each multi-spectral panoramic image is just a few nanoseconds, and the multi-spectral bands have a high image overlap rate. It is noteworthy to point out that different ground objects have different spectral curves and different objects at different wavelength have different spectral radiation responses, so that the multi-spectral panoramic images can be used for identifying the ground objects and has better monitoring and searching effects.

Further, the second capture device 12 comprises a high-resolution capture module 121 and a rotation module 122, and the second capture device 12 can rotate the rotation module 122 to capture a high-resolution image of the target object. The control module 13 is coupled to the first capture device 11 and the second capture device 12 for controlling the second capture device 12 to search and target the azimuth of the target object according to the multi-spectral panoramic images, and then the control module 13 can control the second capture device 12 to rotate the rotation module 122 to capture a high-resolution image of the target object. The processing module 14 is electrically coupled to the control module 13 and provided for computing and recording the attitude information, position information and azimuth of the high-resolution image.

Further, the control module 13 can remotely control the first capture device 11 and the second capture device 12, and the second capture module 12 can search the target object according to the attitude information, position information, azimuth and image characteristic parameter of the target object to capture a high-resolution image of the target object.

In addition, the first capture device 11 and the second capture device 12 can be placed at any position without specific limitations. To make it easier to understand the technical characteristics of the present invention, the first capture device 11 and the second capture device 12 are installed adjacent to each other. Of course, the installation of the first capture device 11 and the second capture device 12 is not limited to such arrangement only.

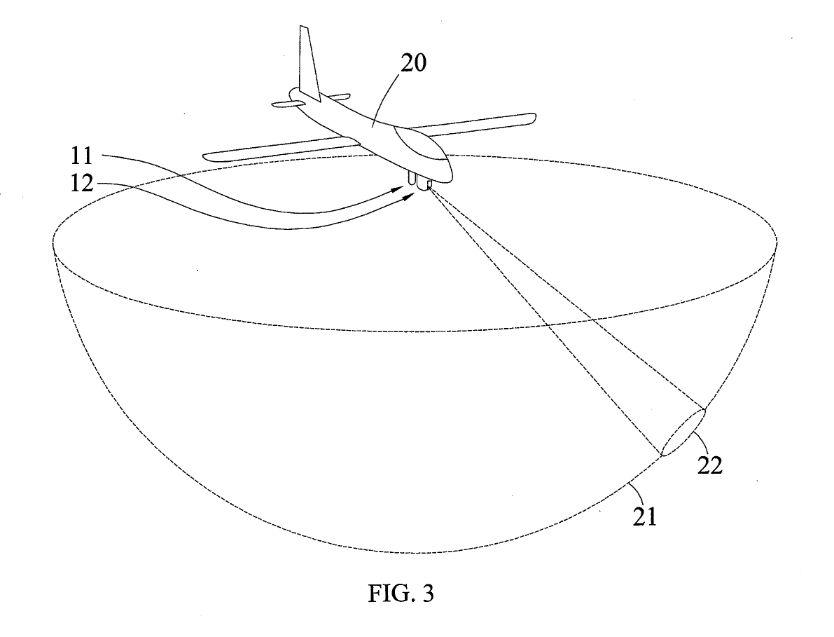

Finally, the storage module 15 stores the high-resolution image, the attitude information, the position information, the azimuth of the high-resolution image, and the capturing time of the target object. The image searching and capturing system 10 of the present invention can store high-resolution images synchronously and record the attitude and position of a moving image searching and capturing system 10. In addition, the high-resolution image of the target object captured by the second capture device 12 can be stored in the storage module 15, or provided for further analysis or determination via a cable or wireless transmission. With reference to FIG. 3 for a schematic view of an image searching and capturing system in accordance with a first preferred embodiment of the present invention together with FIGS. 1 and 2, the image searching and capturing system 10 is installed at a moving carrier such as an aircraft or an UAV 20. For the simplicity of illustrating the technical characteristics of the present invention, the image searching and capturing system 10 is installed in the UAV 20, but the invention is not limited to such arrangement only.

When the image searching and capturing system 10 is carried in the UAV 20, the first capture device 11 can be used at a high altitude, wherein the panoramic capture module 111 is provided for capturing a panoramic image and forming the image at the imaging unit for a panoramic monitoring, and the time-sequence multi-spectral capture module 112 is provided for sequentially capturing a plurality of multi-spectral panoramic images with panorama. Wherein, the first capture device 11 comprises an input unit 13 for inputting an image characteristic parameter of the target object. Therefore, the first capture device 11 captures the multi-spectral panoramic images effectively, and the control module 13 controls the second capture device 12 to search and target the azimuth of the target object according to the multi-spectral panoramic images and the image characteristic parameter of the target object. In this way, the control module 13 controls the second capture device 12 to rotate the rotation module 122 to capture a high-resolution image of the target object.

In other words, the image searching and capturing system 10 uses the panoramic capture module 111 to capture a panoramic image 21 in a large area with a horizontal viewing angle of 360° and a vertical viewing angle of 180°. Since the time-sequence multi-spectral capture module 112 is installed, the multi-spectral panoramic images can be captured at the same time to facilitate the analysis. Particularly, the image searching and capturing system 10 has the effects of searching or monitoring a specific target object, and automatically searching or targeting a target object to reduce the image capturing range to obtain the high-resolution image 22, and the system 10 can be applied for a disaster searching an UAV optical telemetry.

In addition, the image searching and capturing system 10 of the present invention further comprises a processing module 14 electrically coupled to the control module 13 and provided for sensing a 3D acceleration to compute attitude information or inertia data, and receiving a GPS signal and computing the inertia data to obtain position information. Therefore, the control module 13 can control the rotation angle and the rotation direction of the rotation module 122 of the second capture device 12 according to the attitude information and the position information of the image searching and capturing system 10 and the azimuth of the target object.

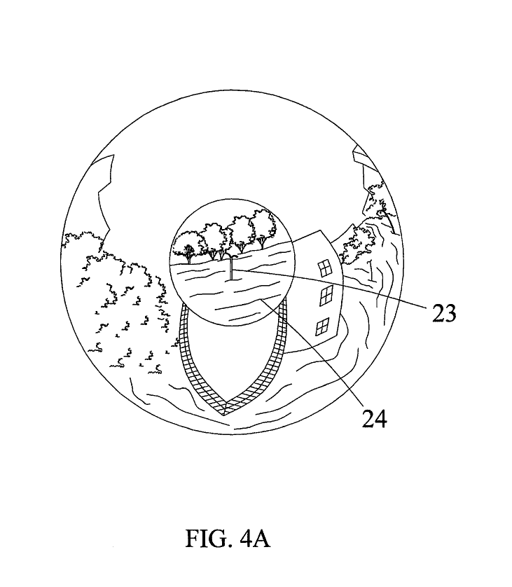

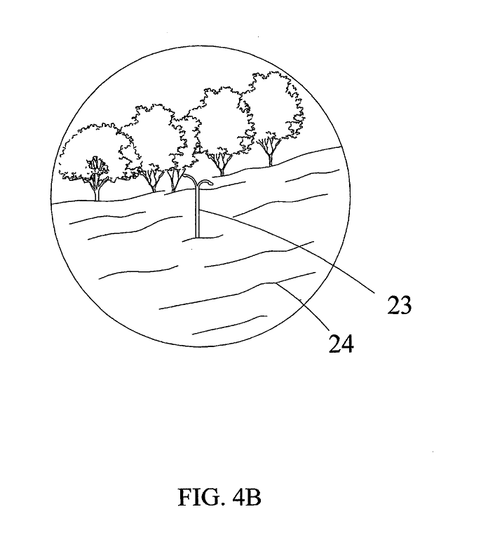

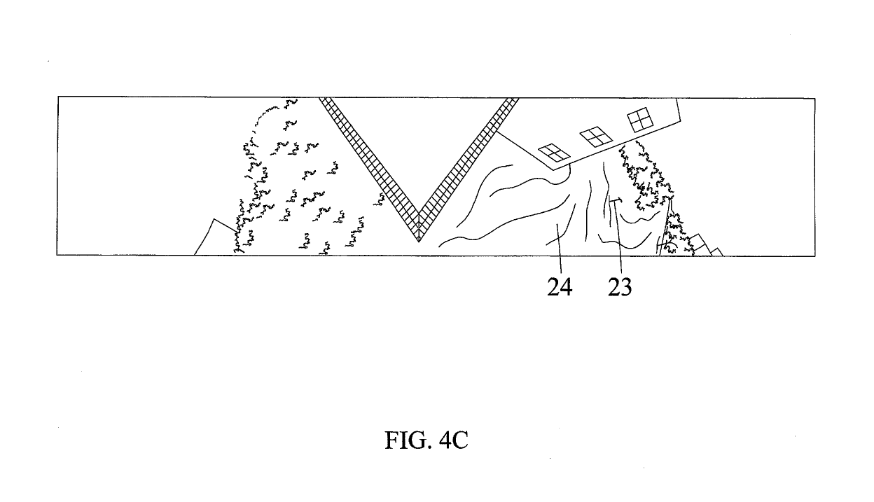

With reference to FIGS. 4A, 4B and 4C for schematic views of first, second and third images of an image searching and capturing system in accordance with a first preferred embodiment of the present invention respectively together with FIG. 1, the image searching and capturing system 10 is installed at an unmanned aerial vehicle (UAV) 20 for capturing a disaster image below the moving UAV 20. If a road is submerged by a flood 24, and a user wants to located a road lamp 23 on the road to determine the original position of the road, then the specific spectrum and image characteristic of the target object (road lamp 23) are searched according to the multi-spectral panoramic images captured by the image searching and capturing system 10, and a high-resolution image of the target object is captured.

In FIG. 4A, a plurality of multi-spectral panoramic images with panorama is captured by the first capture device 11 of the image searching and capturing system 10 sequentially. Even though the multi-spectral panoramic images in FIG. 4A are represented by one color for the purpose of clearly illustrating the panoramic image, it does not mean that there are images of only one spectral band.

Since the panoramic capture module 111 integrates the time-sequence multi-spectral capture module 112, the multi-spectral panoramic images can have the characteristics of the panoramic image and the multi-spectral panoramic images, and several to tens of narrower band information of an environment or scene can be obtained, which include plentiful and informative spectral reflection information of ground objects. Therefore, the target object can be searched according to the multi-spectral panoramic images and the image characteristic parameter of the target object inputted from the input unit 113, such that the image searching and capturing system 10 of the present invention can capture a large quantity of panoramic images and then search a specific target to capture a high-resolution image.

In the captured multi-spectral panoramic images as shown in FIG. 4A, the control module 13 is provided for controlling the second capture device 12 to search a spectral image of a specific target object from the image characteristic parameter of the target object and the multi-spectral panoramic images. The control module 13 is coupled to the processing module 14, and the processing module 14 is provided for sensing a 3D acceleration to compute attitude information or inertia data and receiving a GPS signal to compute the inertia data to obtain the position information and the azimuth of the target object according to the computation of the processing module 14. The image searching and capturing system 10 installed at the UAV 20 can record and store the flying attitude and position of the UAV 20 in the storage module.

With reference to FIG. 4C of a schematic view of a high-resolution image captured by the second capture device together with FIGS. 4A and 4B, the control unit 13 is provided for searching a spectral image of a specific target object, and then targeting the object, and the control unit 13 controls the second capture device 12 to rotate the rotation module 122 to obtain a high-resolution image of the target object. Finally, the storage module 15 stores the high-resolution image of the target object and a capturing time of the high-resolution image of the target object.

Based on the first preferred embodiment, the present invention further provides a second preferred embodiment to further illustrate the invention.

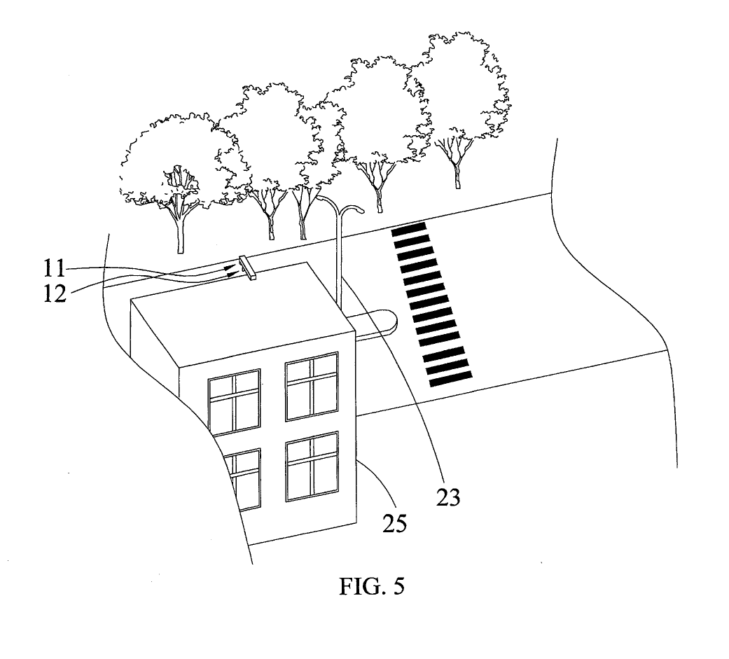

With reference to FIG. 5 for a schematic view of an image searching and capturing system in accordance with a second preferred embodiment of the present invention together with FIGS. 1 and 2, the image searching and capturing system 10 is installed at a fixed carrier in a building 25 or at a road lamp or an intersection and used for an environmental monitoring or a ground monitoring. For the simplicity of illustrating the technical characteristics of the present invention, the image searching and capturing system 10 protruded and mounted at a high position of the building 25 is used as an example for the illustration, but the invention is not limited to such arrangement only.

When the image searching and capturing system 10 is mounted at a high position of the building 25, the system 10 can use a first capture device 11 at the ground, wherein the panoramic capture module 111 is used for capturing a panoramic image and forming the image at the imaging unit to perform a panoramic monitoring, and the time-sequence multi-spectral capture module 112 is used for sequentially capturing a plurality of multi-spectral panoramic images with panorama. The first capture device 11 comprises an input unit 13 for inputting an image characteristic parameter of the target object. Therefore, when the first capture device 11 captures the multi-spectral panoramic images effectively, the control module 13 can be used for controlling the second capture device 12 to search and target the azimuth of the target object according to the multi-spectral panoramic images and the image characteristic parameter of the target object. The control module 13 can control the second capture device 12 to rotate the rotation module 122 to capture a high-resolution image of the target object.

In other words, the image searching and capturing system 10 uses the panoramic capture module 111 to capture a panoramic image 21 of an object in a large area with regard to the ground situation and the surrounding with a horizontal viewing angle of 360° and a vertical viewing angle of 180°. Since the time-sequence multi-spectral capture module 112 is included, therefore, the multi-spectral panoramic images can be captured synchronously to facilitate the analysis. In particular, the image searching and capturing system 10 has the searching and monitoring effects of a specific target object and can automatically search or target a target object to reduce the image capturing range to obtain a high-resolution image 22.

In addition, the image searching and capturing system 10 of the present invention further comprises a processing module 14 electrically coupled to the control module 13. The processing module 14 can sense a 3D acceleration to compute attitude information or inertia data, and receive a GPS signal to compute the inertia data to obtain the position information and azimuth of the target object. Therefore, the control module 13 can control a rotation angle and a rotation direction of the rotation module 122 of the second capture device 12 according to the attitude information and the position information and the azimuth of the target object.

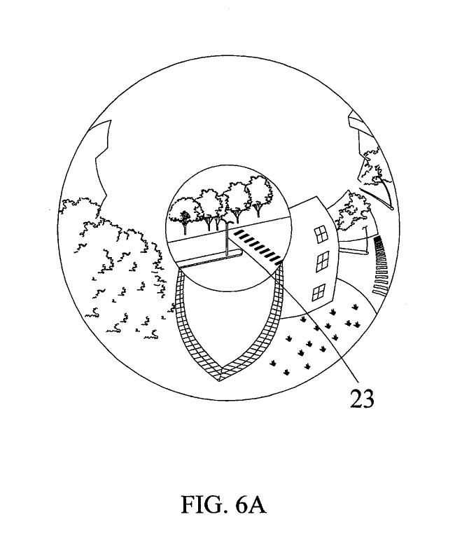

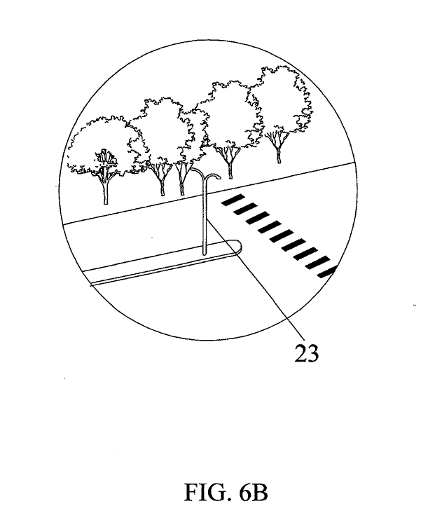

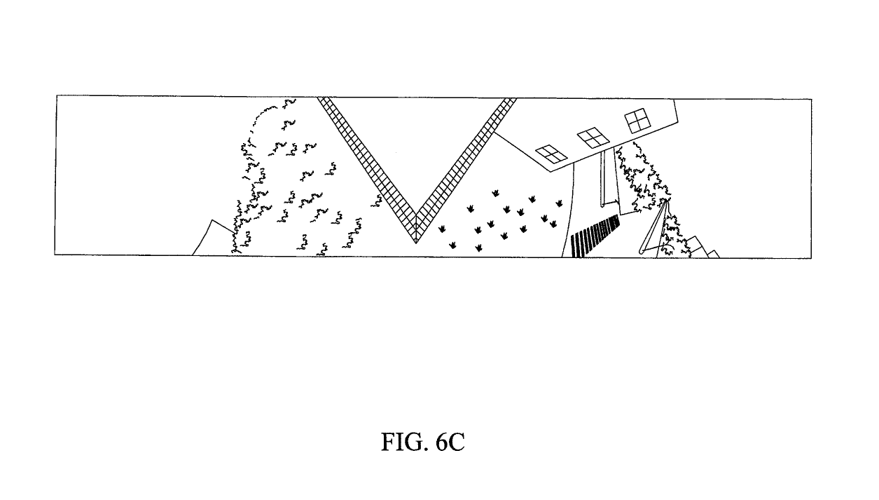

With reference to FIGS. 6A, 6B and 6C for schematic views of first, second and third images of an image searching and capturing system in accordance with a second preferred embodiment of the present invention respectively together with FIG. 1, the image searching and capturing system 10 is installed at a high position and used for monitoring the ground, wherein the input unit 113 is used for inputting and image characteristic parameter of a target object. When a red light turning red, an image of a fast moving object is captured. The image searching and capturing system 10 searches a specific spectrum and an image characteristic of the target object according to the multi-spectral panoramic images captured by the image searching and capturing system 10 in order to target the target object and capture a high-resolution image of the target object.

In FIG. 6A, multi-spectral panoramic images with panorama are captured by the first capture device 11 of the image searching and capturing system 10 of the present invention sequentially. Even though the multi-spectral panoramic images in FIG. 6A are represented by one color for the purpose of clearly illustrating the panoramic image, it does not mean that there are only images of only one spectral band.

In the captured multi-spectral panoramic images as shown in FIG. 6B, the control module 13 is used for controlling the second capture device 12 to search a spectral image of the target object from the image characteristic parameter and multi-spectral panoramic images of the target object. With reference to FIG. 6C for a schematic view of a high-resolution image captured by the second capture device together with FIGS. 6A and 6B, the control unit 13 is used for searching the spectral image of the specific target object, and then the object is targeted, and the control unit 13 is used for controlling the second capture device 12 to rotate the rotation module 122 to capture a high-resolution image of the target object. The storage module 15 stores the high-resolution image of the target object and a capturing time of the high-resolution image of the target object.

The high-resolution image of the target object captured by the second capture device 12 captures is stored in the storage module 15, or transmitted via a cable or wireless transmission for further analysis or determination.

Although the concept of the control method of the image searching and capturing system 10 has been described in the process of describing the image searching and capturing system 10 of the present invention, a flow chart is provided for illustrating the control method as follows.

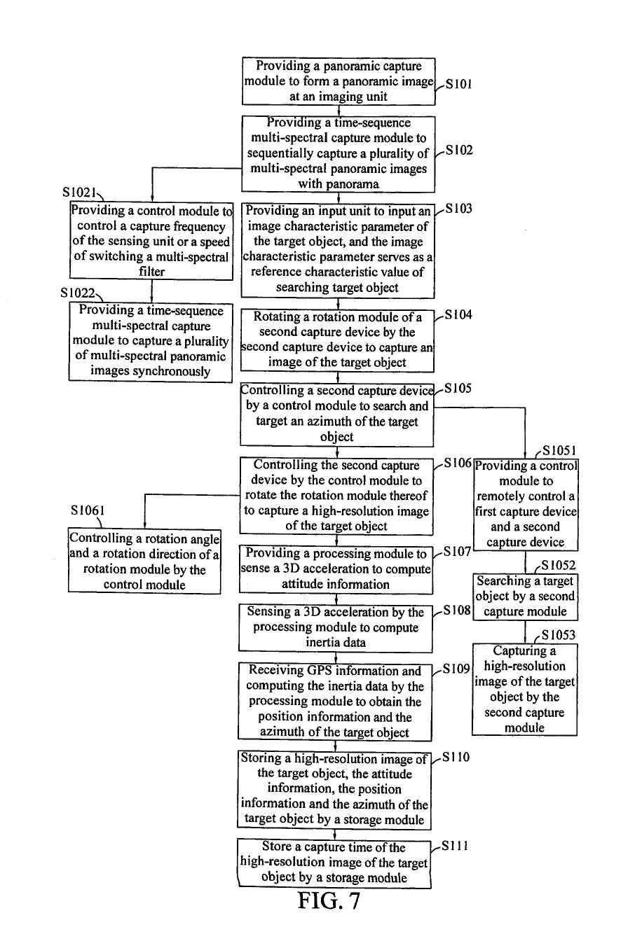

With reference to FIG. 7 for a flow chart of a control method of the present invention, the control method is applied to an image searching and capturing system, and the image searching and capturing system comprises a first capture device, a second capture device, a control module, a processing module and a storage module. The control method of the image searching and capturing system comprises the following steps: In Step S101, a panoramic capture module is provided for forming a panoramic image at an imaging unit. In Step S102, a time-sequence multi-spectral capture module is provided for sequentially capturing a plurality of multi-spectral panoramic images with panorama. Wherein, the panoramic capture module in Step S101 forms the panoramic image at the imaging unit by passing a light source through a panoramic lens and a sensing unit. The Step S102 further comprises the following steps. In Step S1021, a control module is provided for controlling a capture frequency of the sensing unit or a speed of switching a multi-spectral filter. In Step S1022, a time-sequence multi-spectral capture module is provided for capturing a plurality of multi-spectral panoramic images.

In Step S103, an input unit is provided for inputting an image characteristic parameter of the target object, and the image characteristic parameter serves as a reference characteristic value of the search target. In Step S104, a second capture device rotates a rotation module to capture an image of the target object. In Step S105, a control module controls a second capture device to search and target an azimuth of the target object. Wherein, the control module in the step S105 searches and targets the azimuth of the target object according to the multi-spectral panoramic images and the image characteristic parameter of the target object.

The step S105 further comprises the following steps: In Step S1051, a control module is provided for remotely controlling a first capture device and a second capture device. In Step S1052, a second capture module searches a target object. In Step S1053, the second capture module is used to capture a high-resolution image of the target object. In Step S1052, the second capture module can capture the high-resolution image of the target object according to the attitude information, the position information, and the image characteristic parameter of the target object.

In Step S106, the control module is provided for controlling the second capture device to rotate the rotation module to capture a high-resolution image of the target object. In Step S1061, the control module controls a rotation angle and a rotation direction of a rotation module.

In Step S107 to S111, Step S107 provides a processing module to sense a 3D acceleration to compute attitude information; Step S108 senses a 3D acceleration by the processing module to compute inertia data; Step S109 receives GPS information by the processing module and computes the inertia data to obtain the position information and the azimuth of the target object; Step S110 uses a storage module to store a high-resolution image of the target object, the attitude information, the position information and the azimuth of the target object; and Step S111 uses a storage module to store a capturing time of the high-resolution image of the target object.

In summation of the description above, the image searching and capturing system and control method of the present invention have one or more of the following advantages:

(1) The present invention overcomes the problem of the prior art that can only capture images with a small field of view or a large field of view by a camera directly, such that the obtained image with a smaller image field of view cannot search or monitor a scene within a large area.

(2) The image searching and capturing system and control method of the present invention can be applied effectively for environmental monitoring and disaster monitoring, and achieves the effect of obtaining high-resolution images and searching or targeting the object.

(3) The image searching and capturing system and control method of the present invention can use the first capture device to obtain the multi-spectral panoramic images with panorama, the control module to search the azimuth of the target object according to the multi-spectral panoramic images, and control the second capture device to rotate the rotation module to capture the high-resolution image of the target object.

(4) The image searching and capturing system and control method of the present invention can use the control module to control the rotation angle and rotation direction of the rotation module according to the attitude information, the position information and the azimuth of the target object.

What is claimed is:

1. An image searching and capturing system, comprising:
a first capture device, including a panoramic capture module, a time-sequence multi-spectral capture module, and the panoramic capture module having a panoramic lens, a sensing unit and an imaging unit, and the panoramic capture module forming an image with panorama at the imaging unit by passing a light source through the panoramic lens and the sensing unit, and the panoramic capture module integrating the time-sequence multi-spectral capture module, and the time-sequence multi-spectral capture module sequentially capturing a plurality of multi-spectral panoramic images with panorama;
a second capture device, including a high resolution capture module and a rotation module, and the second capture device rotating the rotation module to capture a high-resolution image of a target object;
a control module, coupled to the first capture device and the second capture device for controlling the second capture device and searching and targeting an azimuth of the target object according to the plurality of multi-spectral panoramic images and an image characteristic parameters of the target object, and the control module controlling the second capture device and rotating the rotation module to capture the high-resolution image of the target object; and
a processing module, electrically coupled to the control module, for sensing a 3D acceleration to compute an attitude information or an inertia data, and receive a GPS signal and compute the inertia data to obtain a position information and the azimuth of the target object.

2. The image searching and capturing system of claim 1, wherein the control module controls a rotation angle and a rotation direction of the rotation module according to the attitude information, the position information and the azimuth of the target object.

3. The image searching and capturing system of claim 1, further comprising a storage module storing the high-resolution image, the attitude information, the position information, the azimuth of the target object, and a capturing time of the high-resolution image of the target object.

4. The image searching and capturing system of claim 1, wherein the first capture device further comprises an input unit for inputting an image characteristic parameter of the target object.

5. The image searching and capturing system of claim 1, wherein the time-sequence multi-spectral capture module further comprises a sensing unit coupled to the control module, and the control module controls a capture frequency of the sensing unit or a speed of switching a multi-spectral filter, and the time-sequence multi-spectral capture module captures the multi-spectral panoramic images synchronously.

6. The image searching and capturing system of claim 1, wherein the control module remotely controls the first capture device and the second capture device, and the second capture module searches the target object according to the attitude information, the position information and the image characteristic parameter of the target object to capture the high-resolution image of the target object.

7. A control method, applied in an image searching and capturing system, and comprising the steps of
providing a panoramic capture module to form an image with panorama at an imaging unit by passing a light source through a panoramic lens and a sensing unit;
capturing a plurality of multi-spectral panoramic images with panorama sequentially by a time-sequence multi-spectral capture module;
controlling a second capture device by a control module to search and target an azimuth of a target object according to the plurality of multi-spectral panoramic images and an image characteristic parameter of the target object;
controlling the second capture device by the control module to rotate a rotation module to capture a high-resolution image of the target object;
providing a processing module to sense a 3D acceleration to compute an attitude information or an inertia data; and
receiving a GPS signal through the processing module and computing the inertia data to obtain a position information and the azimuth of the target object.

8. The control method of claim 7, further comprising the step of controlling the rotation angle and the rotation direction of the rotation module according to the attitude information, the position information and the azimuth of the target object by the control module.

9. The control method of claim 7, further comprising the steps of:
storing the high-resolution image of the target object, the attitude information, the position information and the azimuth of the target object by a storage module; and
storing a capturing time of the high-resolution image of the target object by the storage module.

10. The control method of claim 7, wherein the first capture device further comprises an input unit, and the control method further comprises the step of providing the input unit to input the image characteristic parameter of the target object.

11. The control method of claim 7, wherein the time-sequence multi-spectral capture module further comprises a sensing unit, and the control method further comprises the steps of:
providing the control module to control a capture frequency of the sensing unit or a speed of switching a multi-spectral filter; and
capturing the plurality of multi-spectral panoramic images synchronously by the time-sequence multi-spectral capture module.

12. The control method of claim 7, further comprising the steps of
remotely controlling the first capture device and the second capture device the control module;
providing the second capture module to search the target object according to the attitude information, the position information and image characteristic parameter of the target object; and
capturing the high-resolution image of the target object by the second capture module.
